(19) United States
(12) Patent Application Publication
(10) Pub. No.: US 2023/0006502 A1
(43) Pub. Date: Jan. 5, 2023

(54) COOLED ROTARY ELECTRIC MACHINE

(71) Applicant: VALEO EQUIPEMENTS ELECTRIQUES MOTEUR, Creteil Cedex (FR)

(72) Inventors: Pierrick HUSSON, Creteil Cedex (FR); Alexis RIVALS, Creteil Cedex (FR)

(73) Assignee: VALEO EQUIPEMENTS ELECTRIQUES MOTEUR, Creteil Cedex (FR)

(21) Appl. No.: 17/779,861

(22) PCT Filed: Dec. 15, 2020
(86) PCT No.: PCT/EP2020/086225

§ 371 Date: May 25, 2022

(30) Foreign Application Priority Data
Dec. 19, 2019 (FR) FR1914907

(51) Int. Cl. H02K 5/20; H02K 9/19

(52) U.S. Cl. CPC H02K 5/203; H02K 9/19

(57) ABSTRACT

A cooling system for a rotary electric machine having an axis of rotation includes a cooling jacket suitable for receiving a stator of the rotary electrical machine, a housing receiving the cooling jacket, in which an outer wall of the cooling jacket forms, with an inner wall of the housing, a cooling chamber through which a cooling fluid can flow. A separator element separates an inlet zone of the cooling chamber and an outlet zone of the cooling chamber. The separator element includes a fastening part, of a first length, fastened to the outer wall of the cooling jacket or the inner wall of the housing, a first separating part, of a second length, inclined relative to the fastening part and non-parallel to the fastening part. The first length is less than the second length such that the first separating part includes comprises a first free end that is not directly connected to the fastening part. The invention also relates to an electric machine equipped with such a cooling system.

The invention relates to a cooling system for a rotary electric machine and to a rotary electric machine equipped with such a system.

Patent application DE102013213433 discloses a cooling system for a rotary electric machine having an axis of rotation, comprising:
a cooling jacket that is able to receive a stator of the rotary electric machine,
a housing receiving the cooling jacket,

wherein an outer wall of the cooling jacket forms, together with an inner wall of the housing, a cooling chamber that is able to be passed through by a cooling fluid,

and wherein the housing comprises an inlet opening for the inlet of the cooling fluid into an inlet zone of the cooling chamber, and an outlet opening for the outlet of the cooling fluid from an outlet zone of the cooling chamber, the inlet opening and the outlet opening being formed in the housing,

and wherein a separating element, which is separate from the cooling jacket and from the housing, is fixed to one of the outer wall of the cooling jacket and the inner wall of the housing in order to separate the inlet zone of the cooling chamber and the outlet zone of the cooling chamber.

However, it is difficult to fix such a separating element to the cooling jacket. Complex and expensive machining may be required to adapt the separating element to the cooling jacket. In addition, such a separating element is not adapted to a cooling chamber which has a shape exhibiting symmetry of revolution whose axis is the axis of rotation, and the shape exhibiting symmetry of revolution of which has a first thickness, measured at a first axial end, and a second thickness, measured at a second axial end, the first thickness being smaller than the second thickness. Specifically, this type of cooling chamber may have a very small thickness, or even no thickness at one of its ends. It is difficult to adapt the thickness of the separating element to this very small thickness. This lack of adaptation may lead to excessive circulation of cooling fluid between the inlet zone of the cooling chamber and the outlet zone of the cooling chamber. Such excessive circulation around the separating element may reduce the cooling capacity of the cooling system.

The present invention seeks to eliminate all or some of these drawbacks.

The invention relates to a cooling system for a rotary electric machine having an axis of rotation, comprising:
a cooling jacket that is able to receive a stator of the rotary electric machine,
a housing receiving the cooling jacket,

wherein an outer wall of the cooling jacket forms, together with an inner wall of the housing, a cooling chamber that is able to be passed through by a cooling fluid,

and wherein the housing comprises an inlet opening for the inlet of the cooling fluid into an inlet zone of the cooling chamber, and an outlet opening for the outlet of the cooling fluid from an outlet zone of the cooling chamber, the inlet opening and the outlet opening being formed in the housing,

and wherein a separating element, which is separate from the cooling jacket and from the housing, is fixed to one of the outer wall of the cooling jacket and the inner wall of the housing in order to separate the inlet zone of the cooling chamber and the outlet zone of the cooling chamber, the separating element comprising:
a fixing part, with a first length, having a fixing face with a shape that is complementary to the shape of the one of the outer wall of the cooling jacket and the inner wall of the housing to which the separating element is fixed,
a first separation part, with a second length, that is inclined with respect to the fixing part and not parallel to the fixing part,

the first length being smaller than the second length such that the first separation part comprises a first free end which is not directly connected to the fixing part.

The use of a separating element which is separate from the cooling jacket and from the housing makes it possible to simplify the manufacture of the cooling jacket and of the housing and thus to reduce the manufacturing costs of the cooling system and of the machine in which it is used. Specifically, the one of the outer wall of the cooling jacket and the inner wall of the housing to which the separating element is fixed may have a cylindrical shape that is easy to produce.

In addition, the use of a separating element whose fixing part is shorter than its separation part allows better separation between the inlet zone of the cooling chamber and the outlet zone of the cooling chamber. Specifically, since the first end is not limited by the manufacturing constraints of the fixing part, it is possible to produce a free end whose shape is close to the shape of the cooling chamber. The possibilities for the cooling fluid to pass around the separation element are reduced and the cooling of the rotary electric machine is thus improved.

According to an additional feature of the invention, the first separation part forms an angle of between 20 degrees and 160 degrees, in particular between 45 degrees and 135 degrees, with the fixing part.

According to an additional feature of the invention, the first separation part is formed in continuity of material with the fixing part beyond a first bending zone.

Producing a separating element whose first separation part and fixing part are formed in continuity of material and are separated by a bent zone makes it possible to reduce the manufacturing costs of the separating element.

According to an additional feature of the invention, the cooling chamber has a shape exhibiting symmetry of revolution whose axis is the axis of rotation, the shape exhibiting symmetry of revolution having a first thickness, measured at a first axial end, and a second thickness, measured at a second axial end, the first thickness being smaller than the second thickness, and the first free end is oriented toward the first axial end, another end of the first separation part that is opposite to the free end being oriented toward the second axial end.

The use of a cooling chamber exhibiting symmetry of revolution whose thickness at a first end is smaller than its thickness at a second end makes it possible to use a housing and/or a cooling jacket whose manufacturing method, in particular casting and pressing, requires the presence of a taper on the components. Since the free end of the separating element may have a small radial thickness, it is possible to separate the inlet zone of the cooling chamber and the outlet zone of the cooling chamber even in the zones where the cooling chamber is thinnest.

According to an additional feature of the invention, the separating element is made from a sheet material, in particular of sheet steel.

The use of a sheet material makes it possible to simplify the manufacture of the separating element and thus to reduce the manufacturing costs of the electric machine.

According to an additional feature of the invention, an edge surface of the sheet material of the first free end faces toward the one of the outer wall of the cooling jacket and the inner wall of the housing to which the separating element is fixed.

Such a feature allows the shape of the first free end to be adapted to the shape of the chamber. It is thus possible to improve the separation between the inlet zone of the cooling chamber and the outlet zone of the cooling chamber.

According to an additional feature of the invention, the separating element comprises a second separation part, with a third length, that is inclined with respect to the fixing part face and not parallel to the fixing part face, the first length being smaller than the third length such that the second separation part comprises a second free end which is not directly connected to the fixing part.

The use of a separating element comprising a second separation part in addition to the first separation part makes it possible to further improve the separation between the inlet zone of the cooling chamber and the outlet zone of the cooling chamber and thus to improve the cooling performance of the cooling system. Since this improvement in performance does not require the use of additional components, it has a reduced cost.

According to an additional feature of the invention, the second separation part is formed in continuity of material with the fixing part beyond a second bending zone.

According to an additional feature of the invention, the separating element is welded to one of the outer wall of the cooling jacket and the inner wall of the housing.

The invention also relates to an electric machine comprising:
a stator,
a rotor,
a cooling system as described above.

According to an additional feature of the invention, the stator is mounted by force in the cooling jacket.

Throughout the preceding text, the rotor may be a claw-pole rotor. This rotor then comprises a first and a second pole wheel that are nested, the first pole wheel defining a series of claws of trapezoidal overall shape, each claw extending axially in the direction of the second pole wheel, the second pole wheel defining a series of claws of trapezoidal overall shape, each claw extending axially in the direction of the first pole wheel. A permanent magnet may be received between two consecutive claws, circumferentially speaking, for the rotor. As a variant, the rotor may be different than a claw-pole rotor, comprising for example a stack of laminations.

Throughout the preceding text, the rotor may comprise any number of pairs of poles, for example six or eight pairs of poles.

Throughout the preceding text, the rotary electric machine may have a stator having a polyphase electric winding, for example formed by wires or by conducting bars connected to one another.

The rotary electric machine may comprise a power electronic component that is able to be connected to the on-board network of the vehicle. This power electronic component comprises for example an inverter/rectifier that allows an on-board network of the vehicle to be charged, or that can be electrically powered by this network, depending on whether the electric machine is operating as a motor or as a generator.

The rotary electric machine may further comprise a pulley or any other means of connection to the rest of the powertrain of the vehicle. The electric machine is, for example, connected, in particular via a belt, to the crankshaft of the internal combustion engine of the vehicle. As a variant, the electric machine is connected at other locations in the powertrain, for example at the input to the gearbox, from the point of view of the torque passing toward the wheels of the vehicle, on the output side of the gearbox, from the point of view of the torque passing toward the wheels of the vehicle, at the gearbox, from the point of view of the torque passing toward the wheels of the vehicle, or on the front axle assembly or the rear axle assembly of this powertrain.

The rotary electric machine is not necessarily a synchronous machine, and may be an asynchronous machine.

The invention may be understood better upon reading the following description of nonlimiting implementation examples thereof and upon studying the appended drawing, in which:

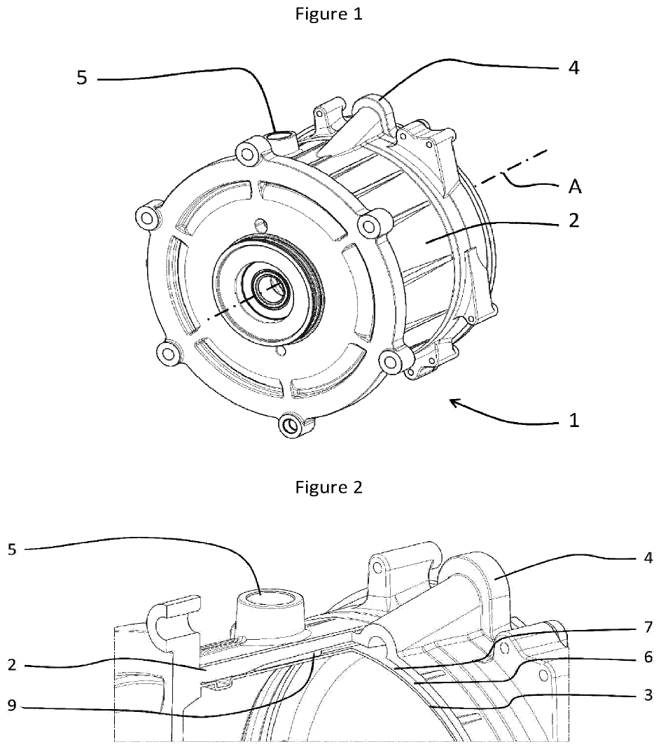

FIG. 1 depicts a partial view of a rotary electric machine comprising a cooling system according to the invention,

FIG. 2 depicts a partial cross-sectional view of the cooling system of the rotary electric machine in FIG. 1 according to a first embodiment,

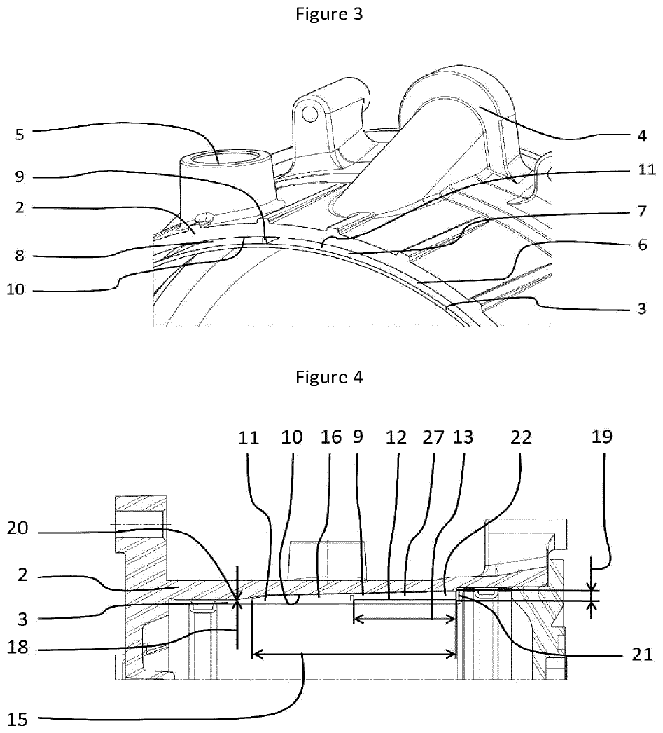

FIG. 3 depicts another partial cross-sectional view of the cooling system of the rotary electric machine in FIG. 1 according to the first embodiment,

FIG. 4 depicts another partial cross-sectional view of the cooling system of the rotary electric machine in FIG. 1 according to the first embodiment,

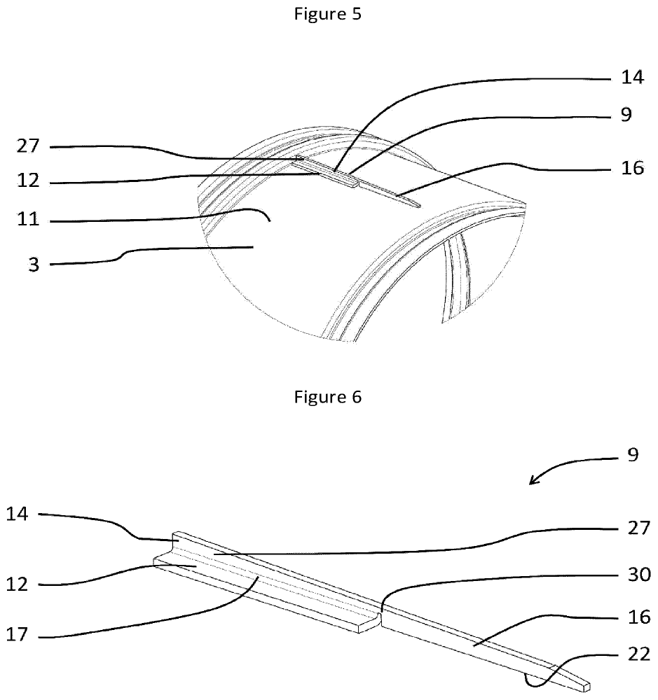

FIG. 5 depicts a partial view of the cooling system of the rotary electric machine in FIG. 1 according to the first embodiment,

FIG. 6 depicts a view of a separating element of the cooling system of the rotary electric machine in FIG. 1 according to the first embodiment,

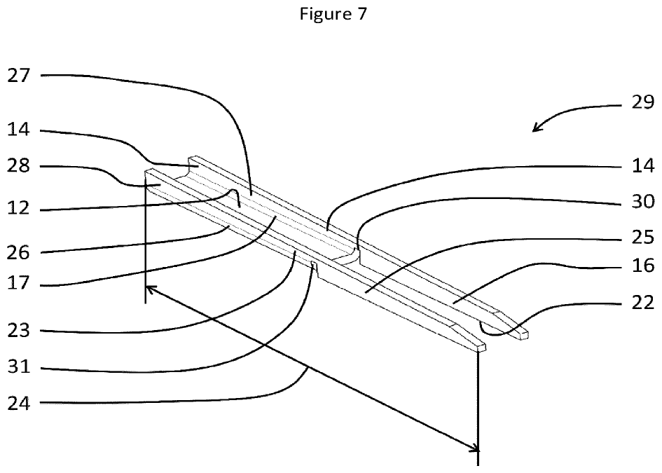

FIG. 7 depicts a view of a separating element of the cooling system of the rotary electric machine in FIG. 1 according to a second embodiment.

Throughout the figures, elements that are identical or perform the same function bear the same reference numbers. The following embodiments are examples. Although the description refers to one or more embodiments, this does not necessarily mean that each reference relates to the same embodiment, or that the features apply only to one embodiment. Individual features of different embodiments may also be combined or interchanged to provide other embodiments.

FIG. 1 and FIG. 2 depict partial views of a rotary electric machine of axis of rotation A comprising a stator, a rotor and a cooling system according to the invention.

To make the figures clearer, certain elements of the rotary electric machine have not been depicted in the figures. In particular, the rotor and the stator have not been depicted.

The cooling system comprises:
a cooling jacket 3 that is able to receive a stator of the rotary electric machine 1,
a housing 2 receiving the cooling jacket.

The cooling jacket is, for example, a cylindrical steel sleeve.

The stator is, for example, mounted by force in the cooling jacket 3.

An outer wall 11 of the cooling jacket 3 forms, together with an inner wall 10 of the housing, a cooling chamber 6.

FIG. 3 depicts a partial view of the rotary electric machine comprising the cooling system according to the invention. A cross section makes it possible to see the cooling chamber.

A cooling fluid circulates in the cooling chamber 6. The housing comprises an inlet opening 4 for the inlet of the cooling fluid into an inlet zone 7 of the cooling chamber 6, and an outlet opening 5 for the outlet of the cooling fluid from an outlet zone 8 of the cooling chamber 6.

The inlet opening 4 and the outlet opening 5 are formed in the housing 2. In the embodiments depicted in the figures, chimneys formed in continuity of material with the housing allow the inflow to the inlet opening 4 and the outlet of the fluid after the outlet opening 5. In another embodiment of the invention, the chimneys are added components, for example tubes force-fitted into the inlet opening 4 and the outlet opening 5.

The cooling system further comprises a separating element 9, which is separate from the cooling jacket 3 and from the housing 2. The separating element 9 is fixed to one of the outer wall 11 of the cooling jacket 3 and the inner wall 10 of the housing 2. The separating element 9 separates the inlet zone 7 of the cooling chamber 6 and the outlet zone 8 of the cooling chamber 6.

This separation between the inlet zone 7 of the cooling chamber 6 and the outlet zone 8 of the cooling chamber 6 prevents an excessively large quantity of cooling fluid from circulating via the shortest path between the inlet opening 4 and the outlet opening 5. The separation promotes the circulation of the fluid into the cooling chamber via the longest path so as to improve the exchanges of heat between the cooling fluid and the cooling jacket 3 which is in thermal contact with the stator.

FIG. 4 depicts the separating element 9 in its environment.

The separating element 9 comprises:
a fixing part 12, with a first length 13, having a fixing face with a shape that is complementary to the shape of the one of the outer wall 11 of the cooling jacket 3 and the inner wall 10 of the housing 2 to which the separating element 9 is fixed,
   a first separation part 14, with a second length 15, that is inclined with respect to the fixing part 12 and not parallel to the fixing part 12.

The first length 13 is smaller than the second length 15 such that the first separation part 14 comprises a first free end 16 which is not directly connected to the fixing part 12.

FIG. 6 depicts the separating element 9 of the cooling system according to a first embodiment.

The fixing part 12 is therefore shorter than the first separation part 14. The first separation part 14 further comprises a first intermediate part 27 which is directly connected to the fixing part 12. The first free end 16 is directly connected to the first intermediate part 27. The first intermediate part 27 therefore provides the connection between the fixing part 12 and the first free end 16.

The first separation part 14 is, for example, formed in continuity of material with the fixing part 12 beyond a first bending zone 17. The first bending zone 17 therefore provides the direct connection between the fixing part 12 and the first intermediate part 27 of the first separation part 14.

The first separation part 14 may form an angle of between 20 degrees and 160 degrees, in particular between 45 degrees and 135 degrees, with the fixing part 12.

In the embodiments of the invention depicted in the figures, the first separation part 14 forms an angle of 90 degrees with the fixing part 12.

The cooling chamber 6 has, for example, a shape exhibiting symmetry of revolution whose axis is the axis of rotation A. The shape exhibiting symmetry of revolution has a first thickness 18, measured at a first axial end 20, and a second thickness 19, measured at a second axial end 21. The first thickness 18 is smaller than the second thickness 19. The first free end 16 is oriented toward the first axial end 20.

Another end 22 of the first separation part 14 that is opposite to the free end 16 is oriented toward the second axial end 21. The other end may form part of the first intermediate part 27.

The separating element 9 is, for example, made from a sheet material, in particular of sheet steel.

The fixing part 12 of the separating element 9 is, for example, welded to the one of the outer wall 11 of the cooling jacket 3 and the inner wall 10 of the housing 2 to which the separating element 9 is fixed.

In the embodiments depicted in the figures, the fixing part 12 has been welded to the outer wall 11 of the cooling jacket 3. FIG. 5 depicts the separating element 9 of the first embodiment of the cooling system, welded to the outer wall 11 of the cooling jacket.

In other embodiments of the invention, other types of fixing may be used, in particular adhesive bonding, brazing or clinching.

An edge surface 22 of the sheet material of the first free end 16 may face toward the one of the outer wall 11 of the cooling jacket 3 and the inner wall 10 of the housing 2 to which the separating element 9 is fixed. The separating element 9 is, for example, press-cut or cut by laser cutting. The edge surface 22 forms part of the cut surface of the sheet material.

The edge surface 22 may be in contact with the one of the outer wall 11 of the cooling jacket 3 and the inner wall 10 of the housing 2 to which the separating element 9 is fixed.

To facilitate the bending and to avoid tearing of the sheet material during the bending between the first separation part 14 and the first intermediate part 27, a first notch 30 may be produced between the first intermediate part 27 and the first free end 16. Such a first notch 30 makes it possible to produce a separating element 9 whose edge surface 22 is close to or in contact with the one of the outer wall 11 of the cooling jacket 3 and the inner wall 10 of the housing 2 to which the separating element 9 is fixed.

FIG. 7 depicts the separating element 9 of the cooling system according to a second embodiment.

The second embodiment of the cooling system according to the invention differs from the first embodiment by its separating element 29. This separating element is similar to the separating element 9 of the first embodiment but it further comprises a second separation part 23, with a third length 24, that is inclined with respect to the fixing part face 12 and not parallel to the fixing part face 12. The first length 13 is smaller than the third length 24 such that the second separation part 23 comprises a second free end 25 which is not directly connected to the fixing part 12.

The fixing part 12 is therefore shorter than the second separation part 23. The second separation part 23 further comprises a second intermediate part 28 which is directly connected to the fixing part 12. The second free end 25 is directly connected to the second intermediate part 28. The second intermediate part 28 therefore provides the connection between the fixing part 12 and the second free end 25.

The second separation part 23 is, for example, formed in continuity of material with the fixing part 12 beyond a second bending zone 26. The second bending zone 26 therefore provides the direct connection between the fixing part 12 and the second intermediate part 28 of the second separation part 23.

The second separation part 23 may form an angle of between 20 degrees and 160 degrees, in particular between 45 degrees and 135 degrees, with the fixing part 12. The separating element 29 of the second embodiment of the invention has a second separation part 23 which forms an angle of 90 degrees with the fixing part 12.

As in the case of the first separation part 14, a second notch 31 may be produced between the second intermediate part 28 and the second free end 25 of the second separation part 23.

In the two embodiments of the invention depicted in the figures, the separation part(s) 14, 23 are planar. In other embodiments of the invention that are not depicted, the separation part(s) 14, 23 are not planar. In another embodiment that is not depicted, the separation part(s) may have an opening or an indentation to allow limited passage of the cooling fluid between the inlet zone of the cooling chamber and the outlet zone of the cooling chamber through the separating element.

1. A cooling system for a rotary electric machine having an axis of rotation, comprising:
a cooling jacket that is able to receive a stator of the rotary electric machine,
a housing receiving the cooling jacket,
wherein an outer wall of the cooling jacket forms, together with an inner wall of the housing, a cooling chamber that is able to be passed through by a cooling fluid,
and wherein the housing comprises an inlet opening for the inlet of the cooling fluid into an inlet zone of the cooling chamber, and an outlet opening for the outlet of the cooling fluid from an outlet zone of the cooling chamber, the inlet opening and the outlet opening being formed in the housing,
and wherein a separating element, which is separate from the cooling jacket and from the housing, is fixed to one of the outer wall of the cooling jacket and the inner wall of the housing in order to separate the inlet zone of the cooling chamber and the outlet zone of the cooling chamber,
the separating element comprising:
aa fixing part, with a first length, having a fixing face with a shape that is complementary to the shape of the one of the outer wall of the cooling jacket and the inner wall of the housing to which the separating element is fixed,
a first separation part, with a second length, that is inclined with respect to the fixing part and not parallel to the fixing part,
the first length being smaller than the second length such that the first separation part comprises a first free end which is not directly connected to the fixing part.

2. The cooling system as claimed in claim 1, wherein the first separation part forms an angle of between 20 degrees and 160 degrees, in particular between 45 degrees and 135 degrees, with the fixing part.

3. The cooling system as claimed in claim 1, wherein the first separation part is formed in continuity of material with the fixing part beyond a first bending zone.

4. The cooling system as claimed in claim 1, wherein the cooling chamber has a shape exhibiting symmetry of revolution whose axis is the axis of rotation, the shape exhibiting symmetry of revolution having a first thickness measured at a first axial end and a second thickness measured at a second axial end, the first thickness being smaller than the second thickness,
and wherein the first free end is oriented toward the first axial end, another end of the first separation part that is opposite to the free end being oriented toward the second axial end.

5. The cooling system as claimed in claim 4, wherein the separating element is made from a sheet material, in particular of sheet steel.

6. The cooling system as claimed in claim 5, wherein an edge surface of the sheet material of the first free end faces toward the one of the outer wall of the cooling jacket and the inner wall of the housing to which the separating element is fixed.

7. The cooling system as claimed in claim 1, wherein the separating element comprises a second separation part, with a third length, that is inclined with respect to the fixing part and not parallel to the fixing part, the first length being smaller than the third length such that the second separation part comprises a second free end that is not directly connected to the fixing part.

8. The cooling system as claimed in claim 7, wherein the second separation part is formed in continuity of material with the fixing part beyond a second bending zone.

9. The cooling system as claimed in claim 1, wherein the separating element is welded to one of the outer wall of the cooling jacket and the inner wall of the housing.

10. An electric machine comprising:
a stator,
a rotor,
a cooling system as claimed in claim 1.

11. The electric machine as claimed in claim 10, wherein the stator is mounted by force in the cooling jacket.

12. The cooling system as claimed in claim 2, wherein the first separation part is formed in continuity of material with the fixing part beyond a first bending zone.

13. The cooling system as claimed in claim 2, wherein the cooling chamber has a shape exhibiting symmetry of revolution whose axis is the axis of rotation, the shape exhibiting symmetry of revolution having a first thickness measured at a first axial end and a second thickness measured at a second axial end, the first thickness being smaller than the second thickness,
and wherein the first free end is oriented toward the first axial end, another end of the first separation part that is opposite to the free end being oriented toward the second axial end.

14. The cooling system as claimed in claim 2, wherein the separating element comprises a second separation part, with a third length, that is inclined with respect to the fixing part and not parallel to the fixing part, the first length being smaller than the third length such that the second separation part comprises a second free end that is not directly connected to the fixing part.

15. The cooling system as claimed in claim 2, wherein the separating element is welded to one of the outer wall of the cooling jacket and the inner wall of the housing.

16. An electric machine comprising:
a stator,
a rotor,
a cooling system as claimed in claim 2.

17. The cooling system as claimed in claim 3, wherein the cooling chamber has a shape exhibiting symmetry of revolution whose axis is the axis of rotation, the shape exhibiting symmetry of revolution having a first thickness measured at a first axial end and a second thickness measured at a second axial end, the first thickness being smaller than the second thickness,
and wherein the first free end is oriented toward the first axial end, another end of the first separation part that is opposite to the free end being oriented toward the second axial end.

18. The cooling system as claimed in claim 3, wherein the separating element comprises a second separation part, with a third length, that is inclined with respect to the fixing part and not parallel to the fixing part, the first length being smaller than the third length such that the second separation part comprises a second free end that is not directly connected to the fixing part.

19. The cooling system as claimed in claim 3, wherein the separating element is welded to one of the outer wall of the cooling jacket and the inner wall of the housing.

20. An electric machine comprising:
a stator,
a rotor,
a cooling system as claimed in claim 3.
